(19) United States
(12) Patent Application Publication
(10) Pub. No.: US 2017/0197873 A1
(43) Pub. Date: Jul. 13, 2017

(54) METHODS AND SYSTEMS RELATING TO ENHANCING MATERIAL TOUGHNESS

(71) Applicant: THE ROYAL INSTITUTION FOR THE ADVANCEMENT OF LEARNING/MCGILL UNIVERSITY, Montreal (CA)

(72) Inventors: François BARTHELAT, Montreal (CA); Seyed Mohammad Mirkhalaf VALASHANI, Montreal (CA); Ahmad Khayer DASTJERDI, Montreal (CA)

(73) Assignee: THE ROYAL INSTITUTION FOR THE ADVANCEMENT OF LEARNING/MCGILL UNIVERSITY, Montreal, QC (CA)

(21) Appl. No.: 15/316,734

(22) PCT Filed: Jun. 8, 2015
(86) PCT No.: PCT/CA2015/000362

§ 371 Date: Dec. 6, 2016

Related U.S. Application Data
(60) Provisional application No. 62/008,757, filed on Jun. 6, 2014.

(51) Int. Cl. C03C 15/00; B32B 38/00; B32B 17/10; B32B 37/12; C03C 23/00; B32B 3/14

(52) U.S. Cl. CPC C03C 15/00; C03C 23/0025; B32B 3/14; B32B 17/10; B32B 37/12; B32B 38/0012; B32B 2457/208; B32B 2307/558

(57) ABSTRACT

Natural materials often boast unusual combinations of stiffness, strength and toughness currently unmatched by today's engineering materials. Beneficially, according to the embodiments of the invention, these unusual combinations can be introduced into ceramics, glasses, and crystal materials, for example by the introduction of patterns of weaker interfaces with simple or intricate architectures. Two-dimensional surface modifications and three-dimensional arrays of effects within these materials allow for the deformation of these materials for increased flexure, impact resistance, etc. Further, the addition of interlocking substrate blocks in isolation or with additional flexible materials provide for improved energy dissipation and toughening. Such modified materials, based on carefully architectured interfaces, provide a new pathway to toughening hard and brittle materials.

### CROSS-REFERENCE TO RELATED APPLICATIONS

This patent application claims the benefit of U.S. Provisional Patent Application 62/008,757 filed Jun. 6, 2014, the entire contents of which are incorporated herein by reference.

### FIELD OF THE INVENTION

This invention relates to materials and more particularly to methods and systems for increasing their deformability, their toughness and their resistance to impact.

### BACKGROUND OF THE INVENTION

Many structural materials found in nature incorporate a large fraction of minerals to generate the stiffness and hardness required for their function (structural support, protection and mastication). In some extreme cases, minerals form more than 95% of the volume of the material, as in tooth enamel or mollusk shells. With such high concentrations of minerals, one would expect these materials to be fragile, yet these materials are tough, durable, damage-tolerant and can even produce ‘quasi-ductile’ behaviours. For example, nacre from mollusk shells is 3,000 times tougher than the mineral it is made of (in energy terms) and it can undergo up to 1% tensile strain before failure, an exceptional amount of deformation compared to monolithic ceramics. The question of how teeth, nacre, conch shell, glass sponge spicules, arthropod cuticles and other highly mineralized biological materials generate such outstanding performance despite the weakness of their constituents has been pre-occupying researchers for several decades.

Accordingly, it would be beneficial for brittle materials to be modified into tough/deformable materials. The inventors have established that the introduction of well-designed interfaces within the same material can completely change its mechanical response. In this manner, the inventors have established that brittle materials, for example glass the archetypal brittle material, can be engineered into a tough and deformable material.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to materials and more particularly to methods and systems for increasing their deformability, their toughness and their resistance to impact.

In accordance with an embodiment of the invention, there is provided a method comprising etching a plurality of features into at least one of the surface and the volume of a first substrate to tessellate a predetermined portion of the substrate, wherein each feature is the boundary of a geometric shape formed by the introduction of weakening interfaces into the material and any defect arising within a feature of the plurality of features is isolated from the remainder of the first substrate by the feature of the plurality of features.

In accordance with an embodiment of the invention, there is provided a substrate comprising:
a first material in sheet form;
first and second layers of a second material, each of the first and second layers disposed on opposite surfaces of the first material, wherein
at least one surface of the first material disposed adjacent one of the first and second layers of the second material has a plurality of features formed over a predetermined portion of the at least one surface of the first material, wherein each feature is formed by the introduction of weakening interface into the first material and any defect arising within the first material under mechanical loading is controlled through at least one of crack deflection, crack bridging, and micro-cracking.

In accordance with an embodiment of the invention, there is provided a method comprising engineering improvements in a predetermined property of a material by the introduction of a plurality of weak interfaces into the material such that the resulting material consists of a plurality of three dimensional interlocking blocks.

In accordance with an embodiment of the invention, there is provided a structure comprising:
a plurality of sheets of first material, each first sheet having a plurality of features formed over a predetermined portion of a surface of the first material adjacent a sheet of a second material, wherein each feature is formed by the introduction of weakening interface into the first material;
a plurality of sheets of the second material, each sheet of the second material disposed between a pair of sheets of the first material.

In accordance with an embodiment of the invention, there is provided a method comprising:
forming a plurality of features within the surface of a first material; and
ultrasonically agitating the first material at a predetermined power for a predetermined time in order to propagate at least one of cracks and micro-cracks within the volume of the first material in order to form a weak interface associated with each feature of the plurality of features.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of examples only, with reference to the attached Figures, wherein:

FIG. 1A depicts graphically toughness versus stiffness values for synthetic materials;

FIG. 1B depicts graphically toughness versus stiffness values for a number of biological materials;

FIG. 2A depicts a 3D laser engraving system configuration;

FIG. 2B depicts the generation of a micro-defect within a transparent material via laser energy absorption for biomimetic materials according to embodiments of the invention;

FIG. 2C depicts an optical image of an array of micro-defects engraved into glass for biomimetic materials according to embodiments of the invention;

FIG. 2D depicts the variation of micro-defect size with laser power for biomimetic materials according to embodiments of the invention;

FIG. 3A depicts a testing configuration for puncture testing materials according to embodiments of the invention;

FIG. 3B depicts puncture force versus displacement responses for a continuous glass plate and for segmented glass plate with R=1.5 mm for biomimetic materials according to embodiments of the invention;

FIG. 3C depicts the puncture performance for a continuous glass plate;

FIGS. 3D to 3F depict the puncture performance for a segmented glass plate with R=1.5 mm for biomimetic materials according to embodiments of the invention;

FIGS. 4A to 4D depict the separation of a touch screen glass structure from a touch screen and its engraving with a hexagonal pattern for defect control and containment according to an embodiment of the invention;

FIGS. 5A and 5B depict the resistance to puncture for engraved and non-engraved touch screen samples together with the test configuration;

FIGS. 6A and 6B depicts the different stages of loading for the non-engraved touch screen sample;

FIGS. 7A and 7B depicts the different stages of loading for the engraved touch screen sample;

FIG. 8 depicts images of fracture patterns for the engraved touch screen showing localization of the damage;

FIG. 9 depicts a cross-lamellar glass sample and its construction according to an embodiment of the invention;

FIG. 10 depicts cross-lamellar glass samples according to embodiments of the invention together with a reference sample;

FIG. 11 depicts the fracture toughness for the different cross-lamellar glass samples according to embodiments of the invention together with the reference sample and representative images of fractured samples;

FIG. 11 depicts the fracture toughness for the different cross-lamellar glass samples according to embodiments of the invention together with the reference sample and representative images of fractured samples;

FIG. 12 depicts the fracture toughness for the Group D cross-lamellar glass samples according to embodiments of the invention against other group samples;

FIG. 13 depicts an “Abeille” 3D interlocking block pattern and its implementation within a borosilicate glass plate according to an embodiment of the invention;

FIG. 14 depicts quasi-static test results for an “Abeille” 3D interlocking block borosilicate glass plate according to an embodiment of the invention;

FIG. 15 depicts impact test results for an “Abeille” 3D interlocking block borosilicate glass plate according to an embodiment of the invention and plain glass;

FIG. 16 depicts a finite element simulation of an “Abeille” 3D interlocking block borosilicate glass plate according to an embodiment of the invention;

FIG. 17 depicts multi-layer glass structure configurations for multi-layer glass samples according to embodiments of the invention;

FIG. 18 depicts force-displacement results for multi-layer glass samples according to embodiments of the invention together with prior art multi-layer glass sample;

FIGS. 19 to 22 depict force-displacement results for multi-layer glass samples according to embodiments of the invention and a prior art multi-layer glass sample together with side-profile image captures of the samples under deformation at different points;

FIGS. 23A to 23D depict laser engraved alumina “jigsaw” test structures according to embodiments of the invention;

FIG. 24 depicts the impact and optimization of locking angle on the “jigsaw” test structures on alumina according to embodiments of the invention;

FIG. 25 depicts load-displacement results for a laser engraved alumina “jigsaw” test structures according to embodiments of the invention;

FIG. 26 depicts load-displacement results for a laser engraved alumina “jigsaw” test structures according to embodiments of the invention with varying locking angle;

FIG. 27 depicts tensile load-displacement results for a laser engraved alumina “jigsaw” test structures according to embodiments of the invention with varying locking angle;

FIGS. 28A and 28B depict a methodology of weakening laser engraved interfaces according to embodiments of the invention together for opaque and transparent materials.

### DETAILED DESCRIPTION

The present invention is directed to materials and more particularly to methods and systems for increasing their deformability, their toughness and their resistance to impact.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

1. Principles of Biomimetic Materials

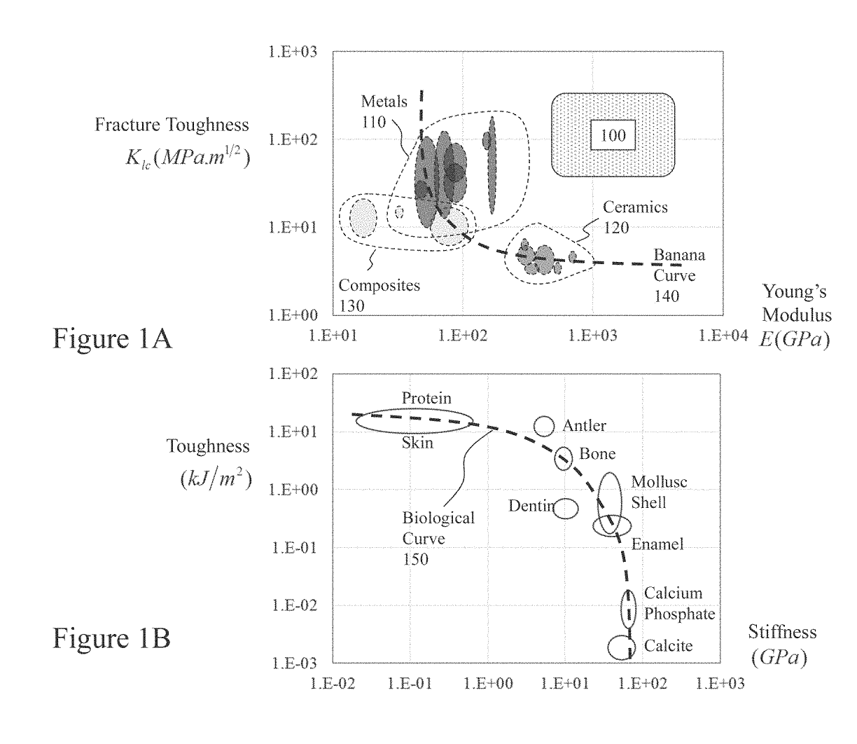

Bio-inspired concepts within the prior art may open new pathways to enhancing the toughness of engineering ceramics and glasses, two groups of materials with very attractive properties, but whose range of applications is still limited by their brittleness. Further, a number of synthetic composite materials inspired from biological materials have been reported, based upon a wide range of fabrication techniques, including ice templating, layer-by-layer deposition/assembly, self-assembly, rapid prototyping and manual assembly. These new materials demonstrate that bio-inspired strategies can be harnessed to achieve both strength and toughness, two properties which are typically exclusive as shown in FIG. 1A where high toughness materials such as metals 110 have low Young's modulus whilst higher Young's modulus materials such as ceramics 120 have low toughness. For example, the strength of steel can be increased by cold working or increased carbon content, but this strengthening invariably comes with a decrease in ductility and toughness. Likewise, engineering ceramics are stiffer and stronger than metals, but their range of applicability is limited because of their brittleness.

Despite the impressive properties displayed by some of these new bio-inspired materials, the level of “toughness” amplification observed in natural materials is yet to be duplicated in synthetic composites 130. Such composites 130 tend to occupy a position of low toughness and low Young's modulus and hence do not sit within the region 100 of desirable engineered materials with both high strength and high toughness. Referring to FIG. 1B, the toughness and strength of a range of natural biological materials are presented demonstrating that high strength and high toughness can be achieved concurrently within the same material. It is evident from FIG. 1B that their properties follow a very different curve, biological curve 150, to the so-called “banana curve” 140 of ceramics, composites, and metals depicted in FIG. 1A.

As such these high-performance natural materials such as nacre, teeth, bone and spider silk boast outstanding combinations of stiffness, strength and toughness which are currently not possible to achieve in manmade engineering materials. For example, dragline silk from spiders surpasses the strength and toughness of the most sophisticated engineering steels, while collagenous tissues such as bone, tendons or fish scales display powerful toughening mechanisms over multiple length scales. Nacre from mollusk shells is 3,000 times tougher than the brittle mineral it is made from and it is one of the toughest materials amongst other mollusks shell materials and other highly mineralized stiff biological materials such as tooth enamel. An examination of the structure and mechanics of these materials reveals a “universal” structural pattern consisting of stiff and hard inclusions embedded in a softer but more deformable matrix. The inclusions are elongated and are parallel to each other, and aligned with the direction of loading within their biological environment. Such structures are particularly well-suited to uniaxial or biaxial tensile loads. In one-dimensional fibers and “ropes” such as spider silk or tendons, uniaxial tension is the only loading configuration. However, more “bulky” materials, such as nacre and bone, undergo multi-axial loading modes but, since these materials are quasi-brittle, tensile stresses are always the most dangerous stresses. Increasing tensile strength is therefore critical to the performance of these materials.

The fundamental mechanism of tensile deformation is the gliding or sliding of the inclusions on one another. In this mechanism the inclusions remain linear-elastic, but the interface dissipates a large amount of energy through viscous deformation. The resulting stress-strain curves display relatively large deformation before failure and, as a result, the material can absorb a tremendous amount of mechanical energy (area under the stress-strain curve). Energy absorption is a critical property for materials like bone, nacre and spider silk, which must absorb energy from impacts without fracturing. Interestingly, the staggered structure has recently been shown to be the most efficient in generating optimum combinations of stiffness, strength and energy absorption by the inventors.

Accordingly, the inventors within embodiments of the invention exploit such hierarchal structures to modify existing materials to implement biomimetic materials that offer characteristics not present within their founding base material.

2. Experimental Results of Biomimetic Material Strain Rate Hardening

3.1 Engraving Weak Interfaces within Bulk Glass

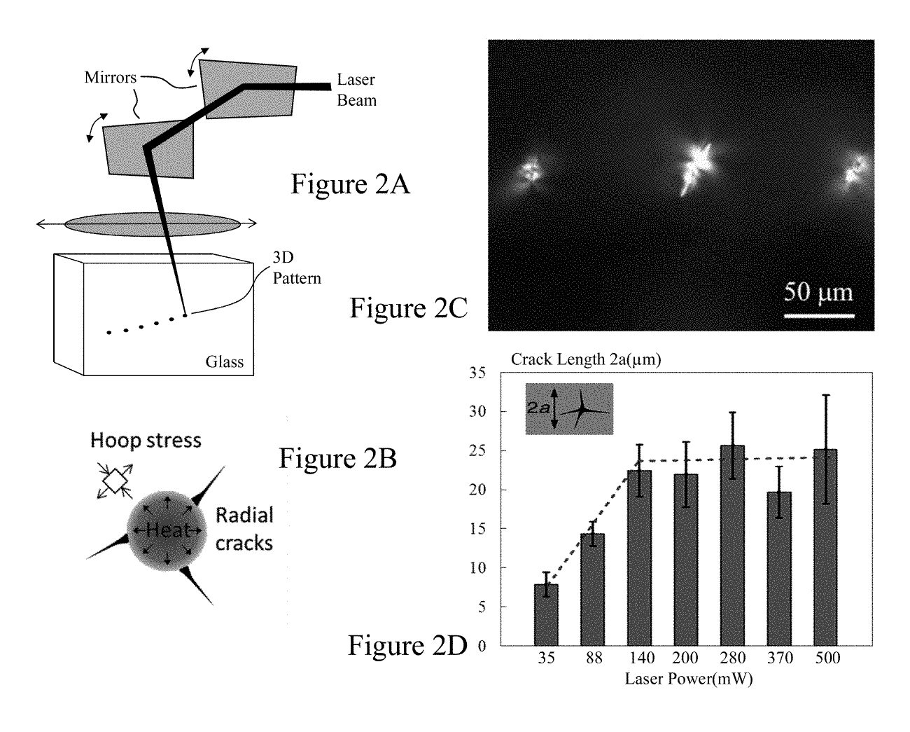

Lasers have been widely used in the past to alter the structure of materials and to generate useful structures such as microfluidic devices or waveguides at small scale and with high accuracy and low surface roughness. Within embodiments of the invention described within this specification, a 3D laser engraving technique was employed, although it would be evident that other techniques to form the structures within the materials may be employed without departing from the scope of the invention. 3D laser engraving as depicted in FIG. 2A consists of focusing a laser beam at predefined points by using a set of two mirrors and a focusing lens. The UV laser beam (355 nm) used here travels in glass with little absorbance, and can be focused anywhere within the bulk of the material. It would be evident that lasers with wavelengths other than 355 nm may be used according factors including, but not limited, to the optical absorption characteristics of the material.

When the system is appropriately tuned, the energy of the unfocused laser beam does not induce any structural changes in glass. However, the heat absorbed at the focal point is sufficient to generate radial microcracks from the hoop stresses associated with thermal expansion as depicted in FIG. 2B. These cracks only propagate over short distances, because the hoop stresses decrease rapidly away from the focal point. With a pulsed laser system, complex 3D arrays of thousands of defects can be engraved in a short period of time and with sub-micrometer precision. Three such defects in an array are depicted in FIG. 2C. The size of the defects can also be tuned by adjusting the power of the laser. For the combination of the glass material and the laser employed in proof-of-principle trials (see Methods section below), a minimum average power of 35 mW was required to generate defects, as shown by the first data point in FIG. 2D. Increasing the laser output power generated larger cracks, following a linear relationship over the range from 35 mW to 140 mW, after which defect size plateaued with the generated defects being of approximately constant size, about 25 μm. This is depicted in FIG. 2D and provided a window sufficiently large to tune the size of the microcracks.

The inventors have demonstrated that the defect spacing employed in creating arrays of defects has a direct effect on the toughness of the interface. For example, with an average defect size of 25 μm then when these defects were very close to each other, spacings of 80 μm and lower, they coalesce on engraving without the application of any external load, effectively cutting the sample in half and giving an apparent toughness of zero. The apparent toughness being defined as the fracture toughness of the interface, K_{IC}⁽ⁱ⁾, normalized by the fracture toughness of the bulk material, K_{IC}^{(b)}. Increasing the spacing between the defects increased the toughness of the interface, up to a spacing of approximately 130 μm. Defects more than 130 μm apart did not interact on application of an external load, and in these cases the apparent toughness was close to the toughness of the intact bulk material, e.g. glass within which no interface was created. Accordingly, the inventors were able to demonstrate that 3D laser engraving can provide a fast and simple approach in generating weak interfaces of tunable toughness within glass.

Accordingly, arrays of such defects can be generated within the bulk of a material, e.g. glass, effectively creating weaker interfaces. Once the weaker interfaces are engraved, the application of an external load may grow the microcracks until they coalesce, effectively channeling the propagation of long cracks. Furthermore, the toughness of the interface can be tuned by adjusting the size or spacing of the defects.

3. Biomimetic Segmented Armour

As a result of the ‘evolutionary arms race’ between predators and prey, many animals have developed protective systems with outstanding properties. The structure and mechanics of these natural armours have attracted an increasing amount of attention from research communities, in search of inspiration for new protective systems and materials. Nature has developed different strategies for armoured protection against predators. While some protective systems are entirely rigid (e.g. mollusk shells) or with only a few degrees of freedom (e.g. chitons), a large number of animals use segmented flexible armours in which the skin is covered or embedded with hard plates of finite size (typically at least an order of magnitude smaller than the size of the animal). In these natural amour systems, the armor plates are typically 1000 to 100,000 times stiffer than the underlying soft skin and tissues.

3.1. Biomimetic Segmented Armour

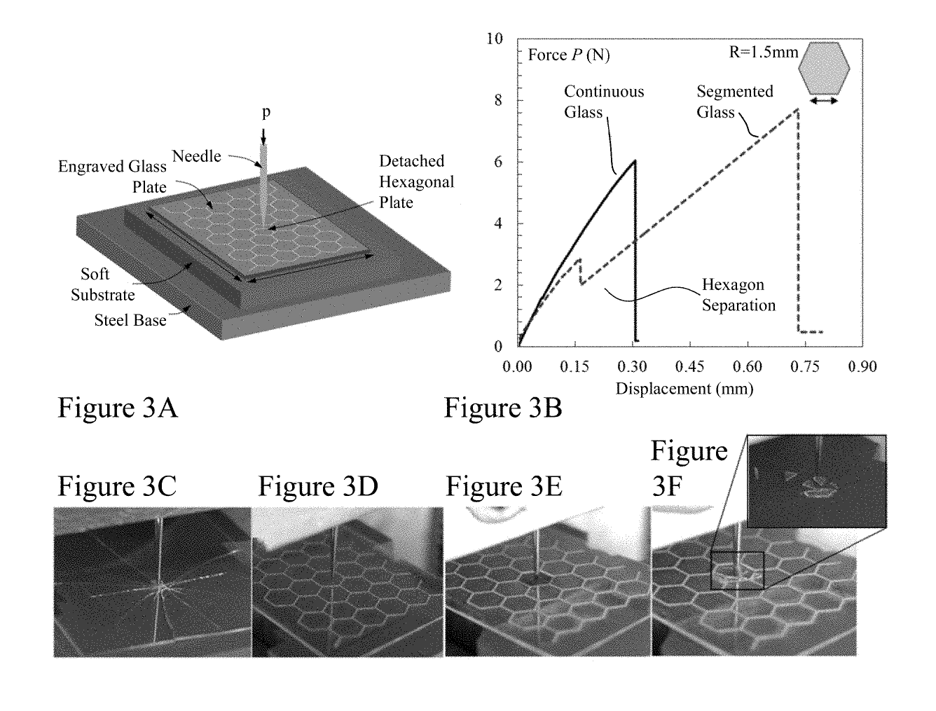

Accordingly, the key attributes selected by the inventors for their biomimetic system consisted of hard protective plates of well-defined geometry, of finite size and arranged in a periodic fashion over a soft substrate several orders of magnitude less stiff than the plates. These attributes generate interesting capabilities such as resistance to puncture, flexural compliance, damage tolerance and “multi-hit” capabilities. The fabrication methodology of the inventors enables the rapid and easy implementation of these attributes with a high level of geometrical control and repeatability. Accordingly, an initial model was based upon 150 μm thick hexagonal borosilicate glass plates as armour segments. The advantages of glass are its hardness and stiffness. Glass is also transparent, a property the inventors exploited here to generate hexagonal patterns by laser engraving but also allowing optical transparent armour to be considered. As depicted in FIG. 3B hexagonal patterns of laser induced microcracks were formed within the glass slide, each line of the pattern consisting of a plane across the thickness of glass and made of hundreds of microcracks 5 μm apart. At laser powers above 35 mW, the minimum required to generate defects within this glass, resulted in defects of dimensions as shown in FIG. 2D of 2a≈8 μm. Increasing the laser output power generated larger cracks, following a linear relationship over the range from 35 mW to 140 mW, after which defect size plateaued with the generated defects being of approximately constant size, about 2a≈25 μm.

Accordingly, following the concept of “stamp holes”, the inventors adjusted the strength of the engraved lines by tuning the size and spacing of the defects. The resulting engraved lines were strong enough to prevent their fracture during handling, but weak enough for the hexagonal plates to detach during the puncture test. Hexagonal plates of different sizes were engraved, ranging from an edge length (R) between 0.25 mm≦R≦6.00 mm. Once engraved, the plate was placed on a block of soft silicone rubber substrate which simulated soft tissues, as depicted in FIG. 3A. The inventors chose a relatively flexible rubber with a modulus of 1 MPa (measured by ball indentation), which is approximately 63,000 times less stiff than the glass plate. In this manner the inventors' synthetic armour system therefore duplicated the main attributes of natural segmented protective system: hard and stiff individual plates of well-controlled shape and size, resting on a soft substrate several orders of magnitude softer than the plate.

4.2. Biomimetic Segmented Armour Puncture Tests

The puncture resistance of the glass layer was assessed with a sharp steel needle with a tip radius of 25 μm that was attached to the crosshead of a miniature loading stage equipped with a linear variable differential transformer and a 110N load cell. The sample was positioned so that the steel needle would contact the plate in the central region of a hexagon before the steel needle was driven into the engraved glass at a rate of 0.005 mm·s⁻¹ until the needle punctured the glass layer, a sudden event characterized by a sharp drop in force. As a reference, continuous glass (non-engraved) was also tested for puncture resistance under similar loading conditions. The silicon rubber used as a substrate had negligible resistance to sharp puncture.

Referring to FIG. 3B, there are depicted typical results for the continuous glass plate, and for a segmented glass plate with hexagonal patterns (R=2 mm). The continuous glass slide shows a linear puncture force-displacement behavior up to a critical force of approximately P_{CRIT}=6N, where the glass layer fractures abruptly. The glass plate shows several long radial cracks emanating from the tip of the needle, many of them reaching the edge of the plate as depicted in FIG. 3C. This type of crack behavior is a characteristic of a flexural failure of the glass plate. Under the point force imposed by the needle the glass plate bends, and flexural stresses increase. Tensile stresses are maximized just under the needle tip and at the lower face of the plate. In this region of the plate, the flexural stresses consist of radial and hoop tensile stresses, which are equal in magnitude. The hoop is responsible for generating the radial cracks observed in FIG. 3B. As the puncture system consisted of a thin plate on a soft substrate, failure from flexural stresses always prevailed over failure from contact stress. This was confirmed by interrupting a few puncture tests prior to the flexural fracture of the plate. No surface damage (indent, circumferential or conical cracks) was detected at and around the contact region, indicating that for all cases the fracture of the glass occurs from flexural stresses only.

The response to puncture of the segmented glass plate (hexagon size R=2 mm) was quite different from the continuous plate as evident in FIG. 3B. The initial response is identical, with a similar stiffness. At a force of about P=2.5 nm a small drop in force is observed, corresponding to the fracture of the engraved contours of the punctured hexagon. After this drop the hexagon is entirely detached from the rest of the plate, and is being pressed into the substrate by the needle. Further displacement requires increased force, but compared to the initial stage the stiffness is lower because it is “easier” to push an individual hexagon into the substrate compared to the continuous plate. Eventually, the hexagon failed from flexural stress, developing multiple radial cracks. As opposed to the continuous plate, the cracks were all confined within the contour of the hexagonal plates. Interestingly, the critical force required to puncture the individual hexagon (P_{CRIT}=7.5N) was higher than that for the continuous glass plate. This sequence being depicted in FIGS. 3D to 3F, respectively.

The reason for this increase in puncture resistance is the result of the interplay between the soft substrate and reduced span. In addition, the work to puncture, measured as the area under the force-displacement puncture curve, was seven times greater for the case of the segmented glass plate. The work required to fracture the glass plate is relatively small, so the increase of work is generated by the deformation of the softer substrate. For the continuous glass plate, the puncture force is distributed over a wide area at the plate-substrate interface, resulting in relatively small stresses and deformation in the substrate. In contrast, once the hexagon detaches from the segmented glass the puncture force is transmitted over a smaller area, with higher stresses transmitted to the substrate, resulting in larger deformations. In addition, the hexagon plate fractures at a higher force compared to continuous glass, further delaying fracture and leading to even more deformations in the substrate. For the case shown in FIG. 3B the displacement at failure is three times larger for the engraved glass compared to the intact glass. Higher force and displacement to failure lead to a much greater work to puncture, which is highly beneficial for impact situations. Whilst within embodiments of the invention have been described and depicted with respect to glass, they may also be implemented on other materials including opaque materials, transparent materials, and those with varying transparency within different regions of the electromagnetic spectrum including, but not limited, to the visible region. Other materials of interest include, but not limited to, high-performance engineering ceramics such as aluminum oxide, boron carbide, and silicon carbide.

4. Touch Screen Damage Control and Containment

Within Sections 2 and 3 a methodology of forming weakened interfaces within a material, e.g. glass, was presented through the exploitation of laser damage induced defects and its use in the formation of segmented armour. However, within a wide range of commercial, industrial, and consumer applications a material, such as a glass for example, is employed due to its overall combination of properties. Amongst these is the exploitation of glass for the front surface of display devices such as those based upon light emitting diodes (LEDs), organic LEDs (OLEDs), active matrix organic LEDs (AMOLEDs), liquid crystal displays (LCD), etc. The combinations of low cost float glass manufacturing, transparency, and hardness under normal operation allow for low cost displays and its compatibility with transparent electrode coatings such as indium tin oxide (ITO) make it suitable for touch and non-touch sensitive displays at dimensions up to 98″ in single devices.

However, in a large proportion of the applications whilst the dimensions may be typically 100 mm-150 mm (4″-6″) or 300 mm-450 mm (12″-18″) the displays are employed on portable devices such as smartphones, portable multimedia players, eReaders, tablet computers, and laptop computers. As a result it is common for users to drop these devices resulting in high impact shocks to the front surfaces, edges, etc. resulting in shattered glass. Accordingly, it is common to see users with shattered displays upon their portable electronic devices which, for other reasons associated with service contracts, etc. on the devices, they maintain using without replacing. Accordingly, it would be beneficial to provide such applications with glass that controlled and contained damage sustained through such high impact shocks.

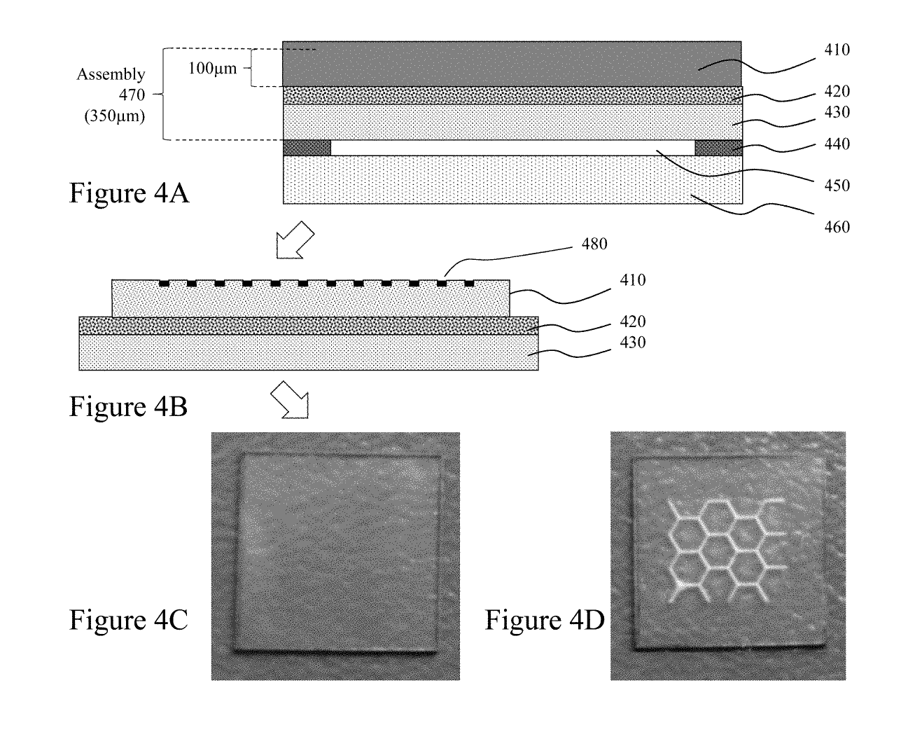

Referring to FIG. 4A there is depicted a cross-section of the front portion of a typical touch-sensitive display which comprises an outer borosilicate glass (BS glass) 410, pressure sensitive adhesive 420, and indium tin oxide (ITO) film on a PolyEthylene Terephthalate (PET) substrate 430 (wherein the ITO film faces towards substrate 460), spacers/edge seal 440, and substrate 460 which may, for example, be ITO coated soda lime silicate float glass wherein the ITO film faces towards PET substrate 430. The spacers/edge seal 440 therefore provide an air gap between PET substrate 430 and substrate 460 wherein the conductive ITO films provide for capacitive based sensing of deflection of the assembly 470 under user touch. This upper assembly 470 of outer BS glass 410, pressure sensitive adhesive 420, and PET substrate 430 being, for example, 350 μm thick, with an upper 100 μm thick BS glass 410.

Accordingly, within embodiments of the invention the inventors formed within the upper surface of the BS glass 410 a pattern of weakened interfaces 480 by laser defect formation at a power of 300 mW with a defect spacing of 5 μm within detached assemblies 470 which had been laser cut from commercially-sourced AMOLED displays as depicted in FIG. 4B and as depicted in FIG. 4C by cut sample/control sample and engraved sample in FIG. 4D. The samples were cut by laser from larger AMOLED displays.

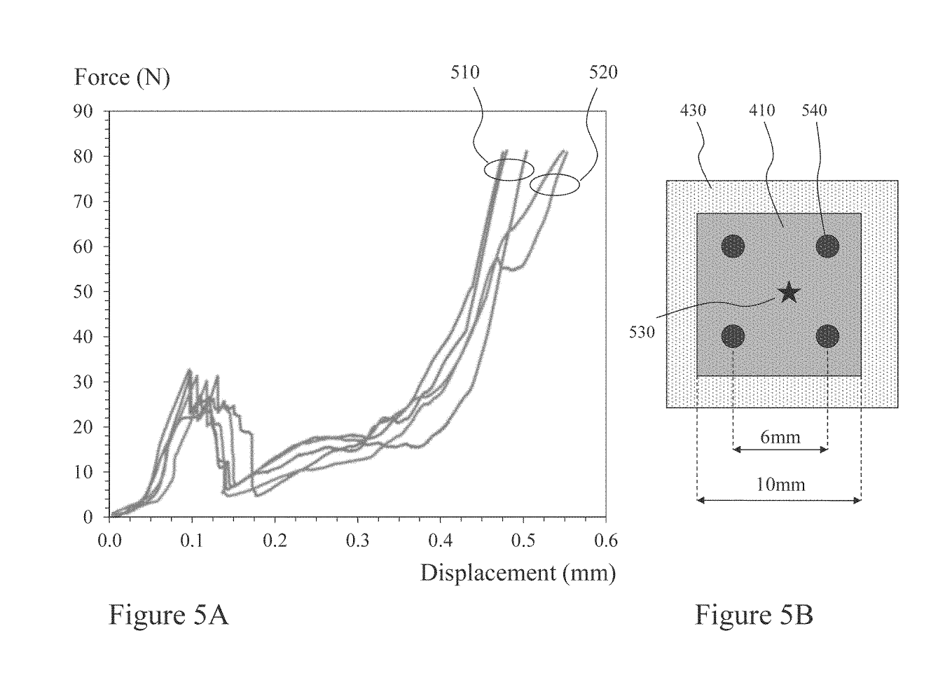

Accordingly, control (non-engraved, FIG. 4C) and test (engraved, FIG. 4D) samples were tested for puncture resistance leading to the results depicted in FIG. 5A. FIG. 5B depicts the geometry of samples wherein the upper BS glass 410 layer was approximately 6 mm square and the lower PET substrate 430 approximately 10 mm square through the laser cutting methodology for forming the test samples. Accordingly, the pattern of spacers 540 can be seen together with the location 530 of the puncture test. Within FIG. 5A first curves 510 relate to the engraved samples according to embodiments of the invention whilst second curves 520 are the control samples.

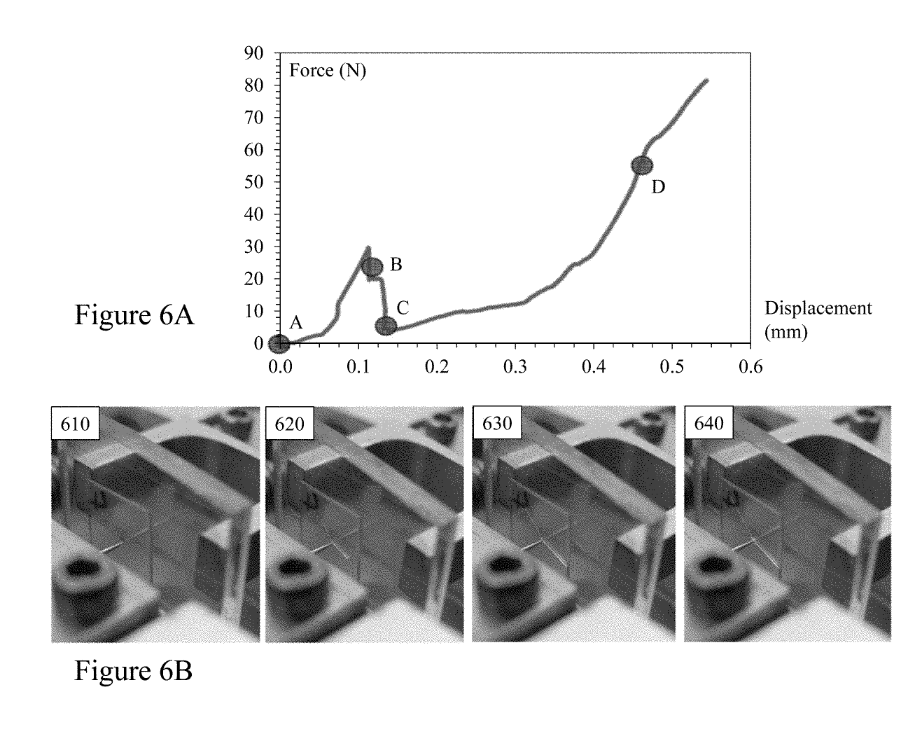

Now referring to FIGS. 6A and 6B there are depicted the different stages of loading for a non-engraved touchscreen control sample. FIG. 6A depicts the displacement-force characteristic together with points A to D which are depicted in FIG. 6B by first to fourth images 610 to 640, respectively. Accordingly, from initial glass, first image 610, the samples cracks initially at step B, second image 620, wherein the cracks propagate under continued loading as evident from third and fourth images 630 and 640 relating to points C and D. Accordingly, as typically occurs in such instances, the cracks propagate across the glass and through the glass.

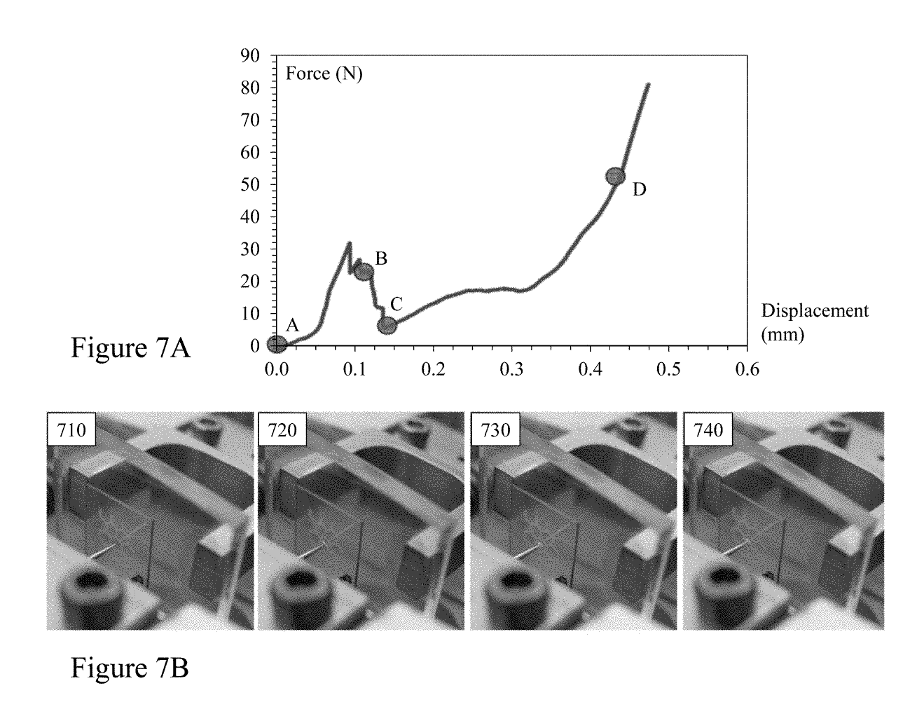

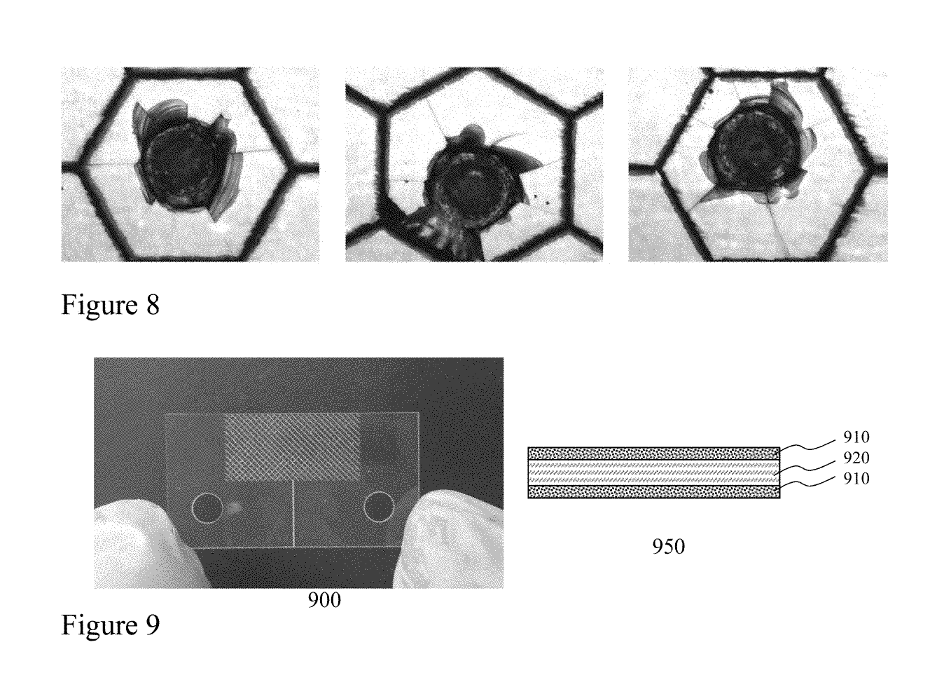

Now referring to FIGS. 7A and 7B there are depicted the different stages of loading for an engraved touchscreen control sample. FIG. 7A depicts the displacement-force characteristic together with points A to D which are depicted in FIG. 7B by first to fourth images 710 to 740 respectively. Accordingly, from initial glass, first image 710, the samples cracks initially punctures at step B, second image 720, wherein the cracks propagate under continued loading but are contained within the hexagonal as evident from third and fourth images 730 and 740 relating to points C and D. Accordingly, unlike the prior art whilst the overall force-displacement curve is essentially the same as continuous prior art glass the fracture-puncture characteristics are now fundamentally different in that the cracks only propagate within the area defined by the weak interfaces, in this instance hexagonal. This is evident from FIG. 8 wherein images of fracture patterns for the engraved touchscreen assemblies 470 according to an embodiment of the invention are depicted showing localization of the damage. Accordingly, embodiments of the invention do not reduce the strength of the touchscreen assemblies 470 but contain damage to very small surfaces of the touchscreen. It is also evident from FIG. 8 that the material surface was engraved. Optionally, non-engraved weakened interfaces may be implemented such that the crack propagation is directed/controlled by the weakened interfaces when the crack impinges it.

The engraving depth can be controlled with high precision so that only the glass layer is engraved while the underlying PET substrate and other pressure sensitive components remain intact. Likewise, the engraving can be performed within the bulk of the glass layer, so that the engraved lines do not intersect with the surface of the screen. In this case the surface of the screen remains intact.

It would be evident to one skilled in the art that the weakened interfaces may be of other polygonal shapes providing a pattern across the material or may be formed from two or more polygonal shapes and that the dimensions of the segments defined by the weakened interfaces may be adjusted according to different factors including, for example, surface material, aesthetics, functionality of structure, etc. Such patterns may include those resulting in tessellation of the surface. In other embodiments of the invention the visual appearance of the engraved surface can be adjusted through filling the engraved lines with an index-matching polymer or other material such that they are visually less distinct.

5. Cross-Lamellar Substrate Structures

Within the touchscreen embodiment of the invention described supra with respect FIGS. 4 to 8 respectively an outer substrate of a three-layer assembly 470 was engraved to fundamentally change the crack propagation characteristics. The upper layer, BS glass 410, being atop a pressure adhesive 420 (polymeric in nature) and lower layer BS glass 430 was engraved. However, in other instances it may not be desirable to have the engraved surface exposed, or to engrave the polymeric layer. Further, in other instances it may be desirable to adjust the characteristics of a lamellar structure or lamellar microstructure composed of, typically fine, alternating layers of different materials. These different materials may be in the form of lamellae.

Accordingly, the inventors proceeded to implement the cross-lamellar structure 950 depicted in FIG. 9 in first image 900 comprising a sequence of polymer 910, engraved sample 920, and polymer 910. Within the embodiments of the invention presented below the polymer 910 was polyurethane. During fabrication of the cross-lamellar structure 950 glass substrates were applied to either side to provide uniform pressure.

A typical manufacturing sequence for cross-lamellar structure 950 comprising the following sequence of process steps:
1) Laser engrave the engraving pattern upon sample 920 (in trials a protective frame was also etched in this step);
2) Laminate the sample 920 with polymer 910;
3) Add glass plates for distributing clamping pressure, such that now the material order is glass-polymer 910-sample 920-polymer 910-glass;
4) Apply clamping;
5) Vacuum back in oven at 105° C. for 3 hours;
6) Remove clamps and glass plates;
7) Laser cut the protection frame such that the engraved region is at the edge of the test piece and laser cut mounting holes and initial slot.

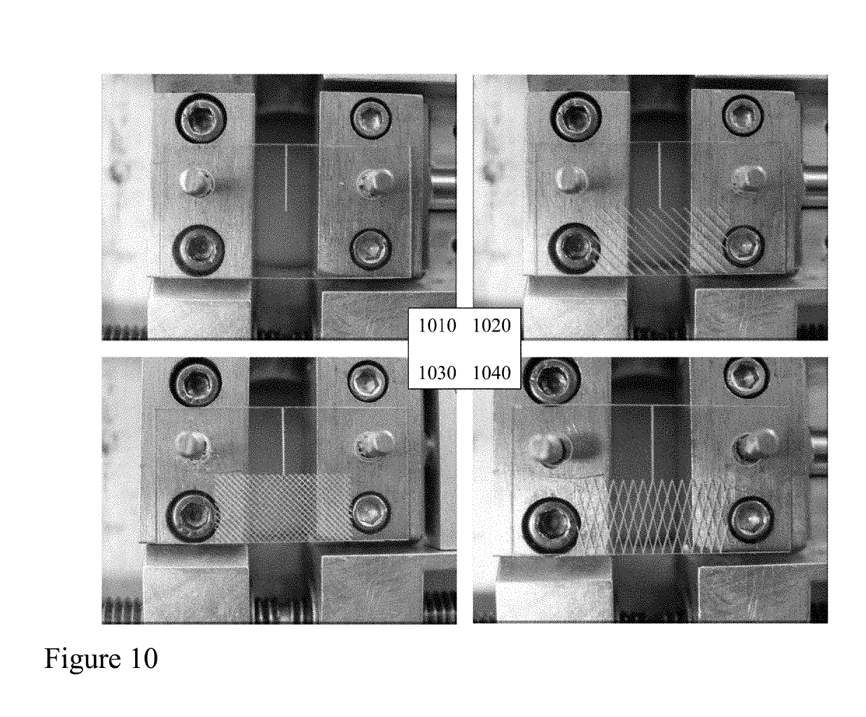

Four different sample groups were generated together with reference samples employing normal glass without laser defect-etch processing. These are summarized in Table 1 below. A sample for the reference cross-lamellar structure is depicted in first image 1010 in FIG. 10 wherein the sample mounting into the test fixture with pins projecting through laser cut holes and the initial “crack” (also laser cut) are clearly visible. Second to fourth images 1020 to 1040 respectively in FIG. 10 depicts cross-lamellar glass samples from groups A, B, and D respectively.

TABLE 1
Cross-Lamellar Sample Parameters

| | Sample | Polymer (PTFE) | Angle of | Etched |
|---|---|---|---|---|
| | Thickness | Thickness | Etched | Line Spacing |
| Group | (mm) | (mm) | Lines | (mm) |
| O | 0.15 | 0.05 | NA | N/A |
| A | 0.15 | 0.05 | ±45° | 1.0 |
| B | 0.15 | 0.05 | ±45° | 0.5 |
| C | 0.15 | 0.05 | ±30° | 1.0 |
| D | 0.15 | 0.05 | ±15° | 1.0 |

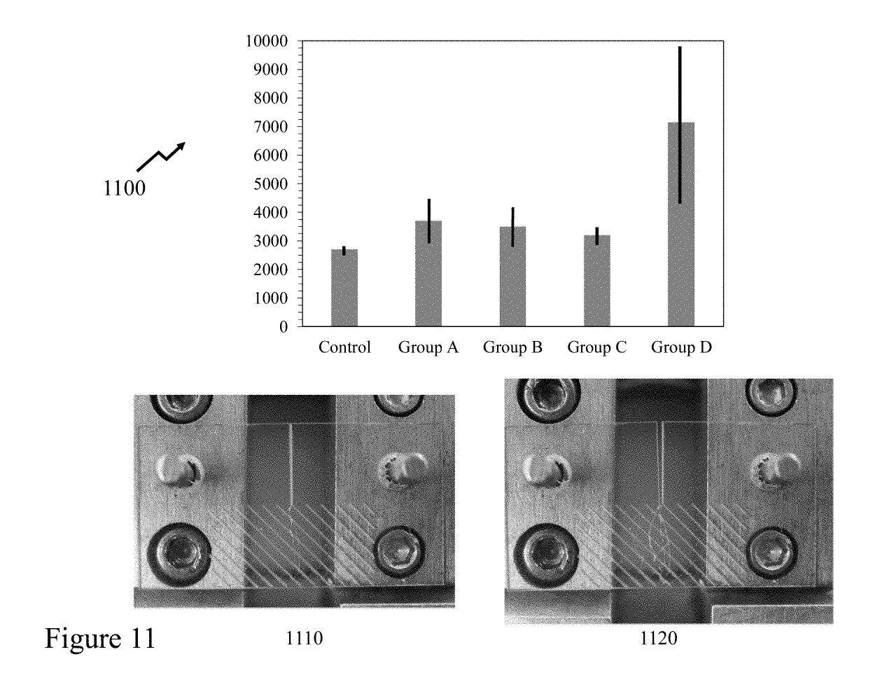

The test sample groups were then evaluated for their work of fracture resulting in the results plotted in graph 1100 in FIG. 11 wherein it can be seen that whilst groups A, B and C had an improvement in work of fracture relative to the reference samples (Group O) that these improvements were relatively minor compared to the improvement evident from Group D. First and second images 1110 and 1120 in FIG. 11 depict the resulting crack propagation observed for two samples from Group A. Here, compared to normal laminated glass, the path of crack propagation appears to be random, although it is guided by the weak interfaces, and there is evidence of toughening mechanisms that the inventors have identified, namely crack deflection, crack bridging, and micro-cracking.

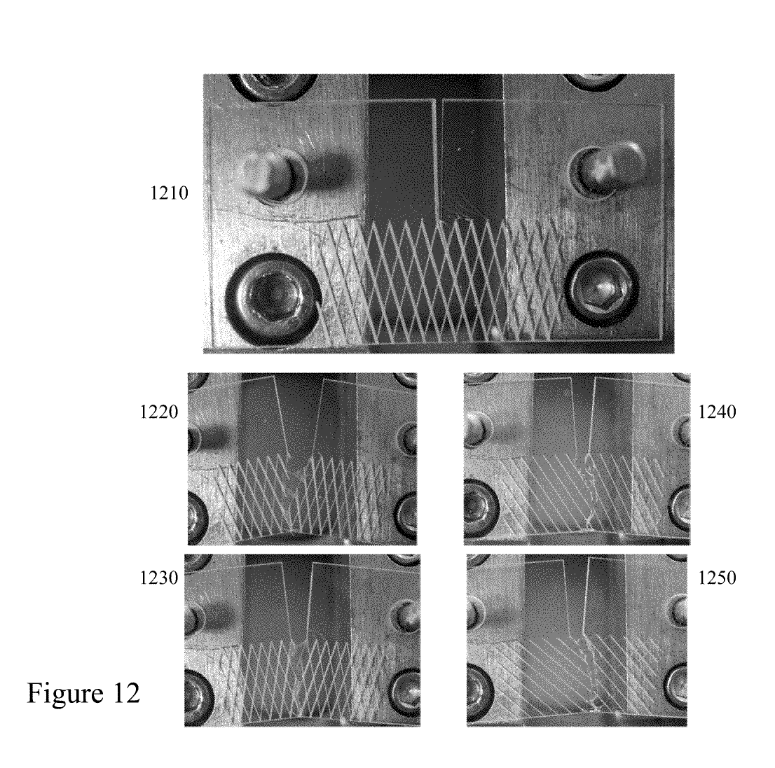

Now referring to FIG. 12 first image 1210 depicts the fracture performance of a Group D cross-lamellar glass sample according to an embodiment of the invention wherein the crack has propagated along the reduced strength interface engineered into the sample. Similar performance is observed within second and third images 1220 and 1230 even though the crack has not propagated down a single interface but multiple interfaces. In contrast, fourth and fifth images 1240 and 1250 are representative of other group fracture propagations, e.g. Groups A, B and C. As evident the fractures do not follow the weak interfaces. Additionally, the samples in Group D demonstrate a large area of crack bridging by the polymer (PTFE) which is evident between the glass sample pieces in second and third images 1220 and 1230 respectively.

6. Interlocking Block Engineered Substrates

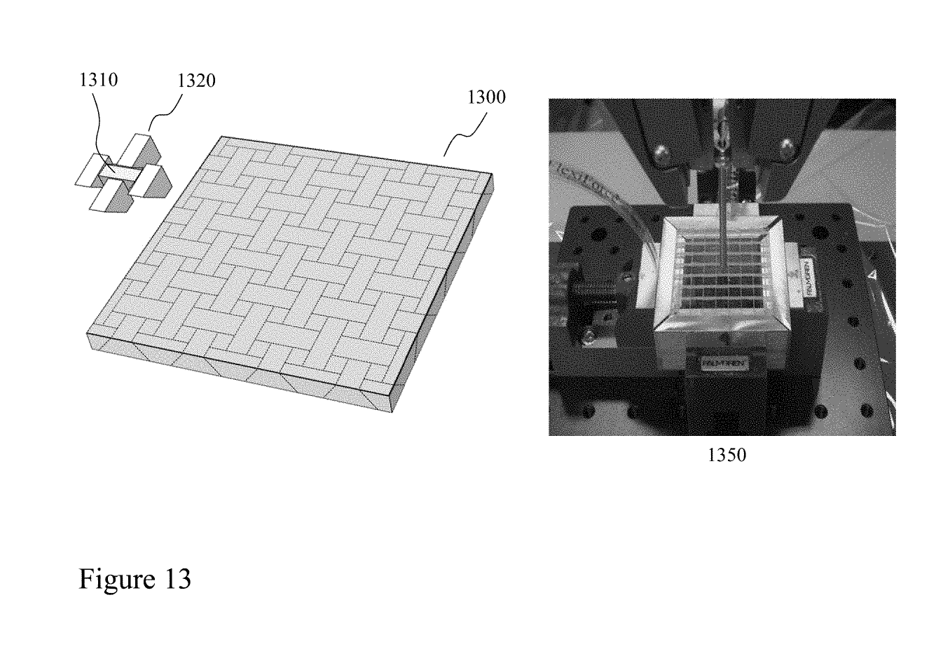

Within the preceding Sections 4 and 5 the re-engineering of a material through surface micromachining has been presented with respect to improving the tensile performance and/or fracture toughness of a material, e.g. glass. However, in other instances the desired characteristic is resistance to puncture, as with armour, such as described supra in respect of Section 3. Accordingly, the inventors have exploited their rapid low cost manufacturing methodologies to the formation of so-called “Abeille” interlocking block patterns wherein arrayed geometric blocks are self-locking to provide a physically coherent structure wherein no elements are physically attached to one another. Such an “Abeille” interlocking block pattern is depicted in FIG. 13 with first image 1300 and its implementation within a borosilicate glass plate according to an embodiment of the invention in second image 1350 which is mounted within a puncture test system.

Accordingly, as depicted in first image 1300 the structure comprises a pattern of blocks 1310 and 1320 with angled interfaces which go through the thickness of the structure such that the interfaces define interlocking “blocks” in the shape of truncated tetrahedra. The underlying concept being that these blocks slide relative to one another upon impact thereby dissipating the impact rather than locally absorbing it and failing. The sample presented in FIG. 13 in second image 1350 was 2″×2″×⅛″ (approximately 51×51×3.2 mm) with an array of 81 interlocking blocks each approximately 7/32″× 7/32″×⅛″ (approximately 5.6×5.6×3.2 mm).

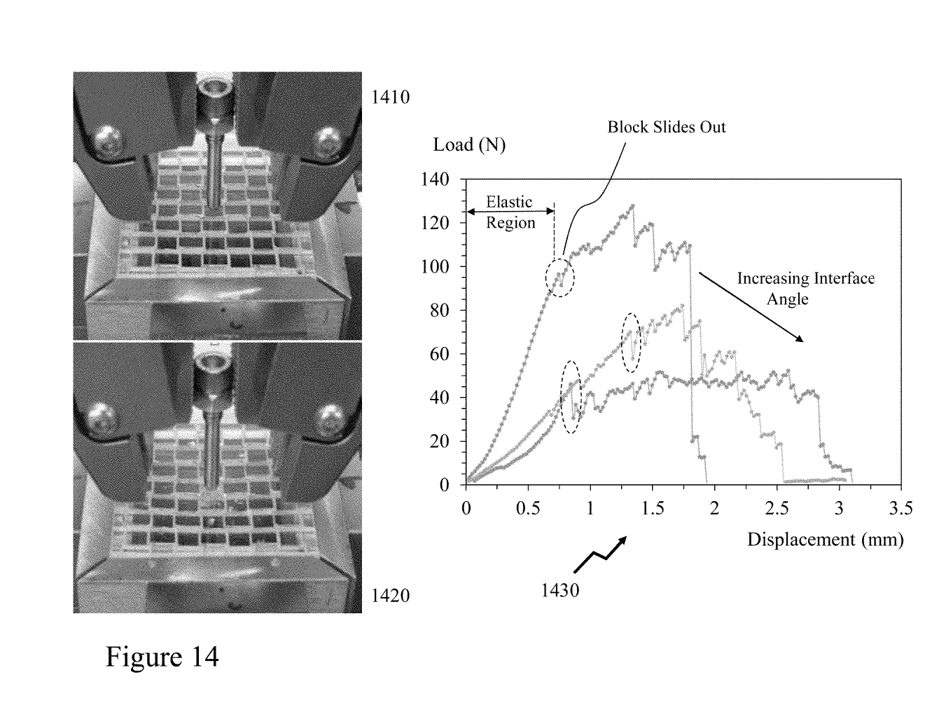

Referring to FIG. 14 there are depicted quasi-static test results for this “Abeille” 3D interlocking block borosilicate glass plate according to an embodiment of the invention wherein in first and second images 1410 and 1420 the interlocking block borosilicate glass plate is shown before and after puncture test whilst graph 1430 presents the puncture test results for interlocking block borosilicate glass plates with varying interface angle. In each instance the initial response is elastic until a critical force is reached, which depends on interface angle, wherein the indented blocks shows surface damage and starts sliding downward. Subsequently, under increasing force the dislodged block gets pushed out of the plate but prior to this and during the plate absorbs a significant amount of energy, by friction at the interface.

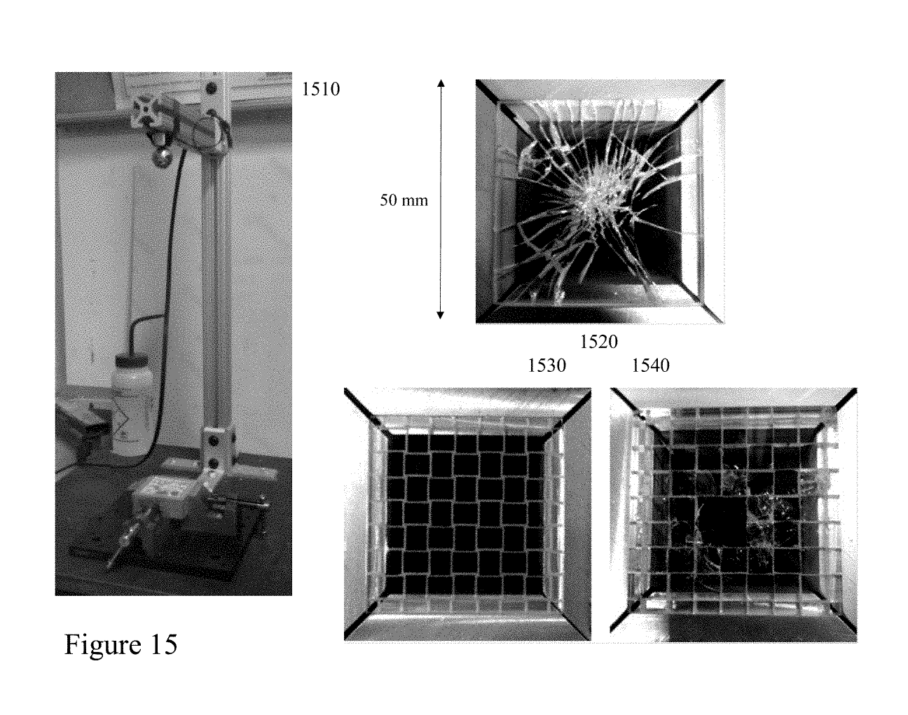

Now referring to FIG. 15 there are depicted impact test results for an “Abeille” 3D interlocking block borosilicate glass plate according to an embodiment of the invention and plain glass. First image 1510 depicts the drop test system comprising a steel ball which is dropped by releasing an electromagnet on a precision slide from a pre-set height. Accordingly, the kinetic energy can be calculated from the height and mass of the steel ball. By starting at a low height and increasing the height until the plate fractures allowing an estimate of the impact energy that the material can absorb without failing. In these tests a 23 mm steel ball of mass 67.5 g was employed. Referring to second image 1520 a plain borosilicate plate after the testing is depicted wherein the plate absorbs impact energies up to 0.33 J. Below that the ball rebounds and the impact energy is largely stored in elastic stresses of the plate and recovered to make the ball rebound. At impacts above 0.33 J the fracture is brittle and catastrophic.

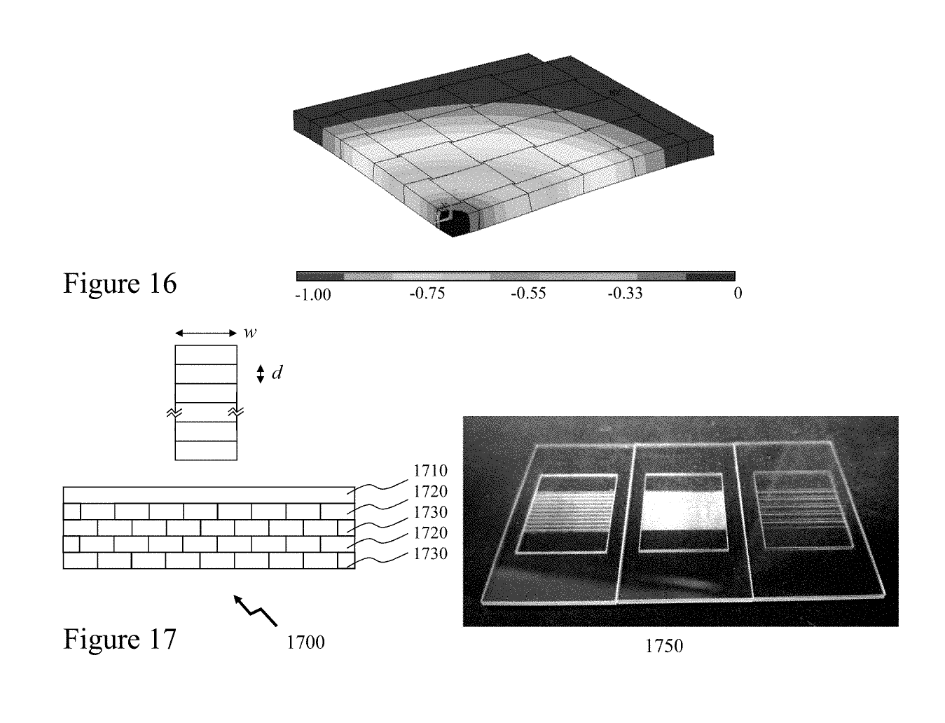

Referring to third and fourth images 1530 and 1540 a plate according to an embodiment of the invention is depicted before and after testing to failure. At low drop heights the ball rebounds but as the drop height increases the rebound greatly decreases as the impact energy is absorbed by the material: The material relies on toughness and energy absorption to resist impact. Initial samples failed at impact energies 67% higher than the prior art plain glass plate, i.e. approximately 0.55 J. At failure only a few blocks fail near the impact site whilst the remainder of the plate is intact. Potentially, the broken blocks may even be replaced in other instances. This can also be seen from FIG. 16 wherein the results for a finite element simulation of an “Abeille” 3D interlocking block borosilicate glass plate according to an embodiment of the invention are presented wherein it can be seen that at impact the plate deforms to a maximum deflection of approximately 1 mm.

As opposed to traditional impact resistant designs for glass, e.g. tempered glass, laminated glass, safety glass, etc., which are based on high strength materials but which are not tough, i.e. they store the energy of the impact and the impactor rebounds, the new engraved materials according to embodiments of the invention absorbs the energy of the impact and rely on toughness to resist fracture. The impact resistance can be further improved by adjusting the interlocking angle between the blocks, which can be done with the aid of finite element computer simulations, and/or by infiltrating the engraved interfaces with a transparent polymer such as polyurethane or an ionomer resin, for example.

7. Multi-Layered Lamellar Glasses

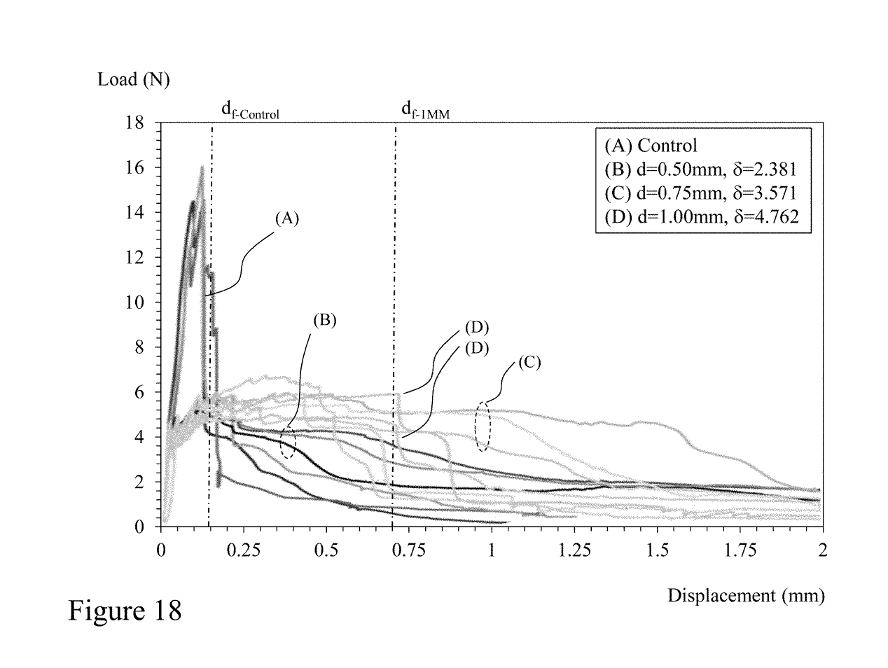

As noted supra in respect of Section 5 a lamellar structure or lamellar microstructure is composed of alternating layers, generally of different materials, which may be in the form of lamellae. Referring to FIG. 17 with first image 1700 a lamellar structure according to an embodiment of the invention is depicted comprising a plurality of layers with continuous sheet 1730 atop a pair of alternating layers, namely first blocked sheet 1720 and second blocked sheet which are formed from blocks of identical dimensions but the sheets are offset relative to one another. First blocked sheet 1720 and second blocked sheet 1730 may in fact be the same starting material sheet. Within the experiments performed by the inventors four sample configurations were tested, denoted as Groups A to D, wherein the parameters for these are defined in Table 2 below. Disposed between each pair of glass layers is a polymer layer, not depicted for clarity.

TABLE 2
Lamellar Layer and Glass Block Parameters

| | | Intermediate | | | |
|---|---|---|---|---|---|
| | Glass | Polymer | Block | Block | |
| | Thickness | Thickness | Width | Length | Overlap |
| Group | (mm) | (mm) | (d) (mm) | (w) (mm) | (%) |
| A | N/A | N/A | N/A | N/A | N/A |
| B | 0.21 | 0.05 | 0.50 | 2.37 | 50 |
| C | 0.21 | 0.05 | 0.75 | 2.37 | 50 |
| D | 0.21 | 0.05 | 1.00 | 2.37 | 50 |

Now referring to FIG. 18 there are depicted the force-displacement results for multi-layer glass samples (Groups B-D) according to embodiments of the invention together with prior art multi-layer glass sample (Group A). The vertical line marked d_{f-CONTROL} represents the displacement for the control prior art multi-layer glass samples in Group A. For the Groups B-D according to embodiments of the invention it is clear that the strength of these is less than half that of the control group, Group A, from the load data. However, for the control group at each d_{f-CONTROL} there is only a single large drop in the displacement-load profile. For Groups B and C with aspect ratios of δ=2.381 and δ=3.571 (5=d/t_{g}) it can be seen that there is no clear drop and that the force gradually decreases. However, for δ=4.762 we see that the displacement for failure, d_{f-1MM}, is significantly larger than that of the control group and that there are several drops evident.

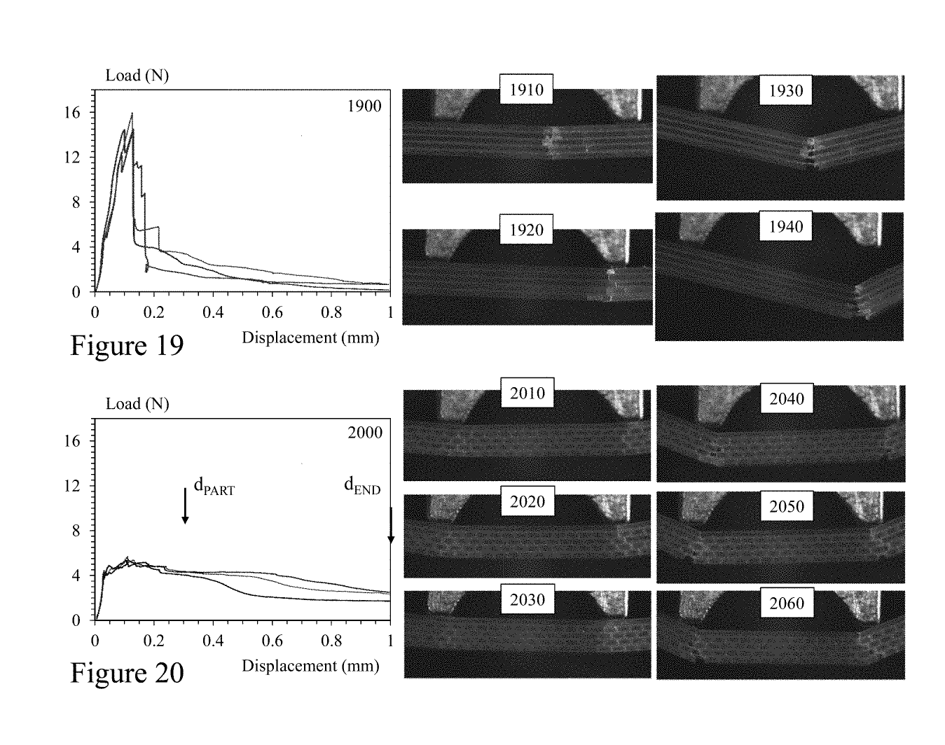

Now referring to FIGS. 19 to 22 respectively the force-displacement results for each of Groups A-D are presented individually together with side-profile images captured of the samples under deformation at different points. These being:

FIG. 19—Group A: First and second images 1910 and 1920 for the samples at d_{f-CONTROL} and third and fourth images 1930 and 1940 at full 1 mm displacement.

FIG. 20—Group B: First to third images 2010 to 2030 respectively for the samples at d_{PART} and fourth to sixth images 2040 to 2060 respectively at full 1 mm displacement, wherein it can be seen that the structure still maintains structure;

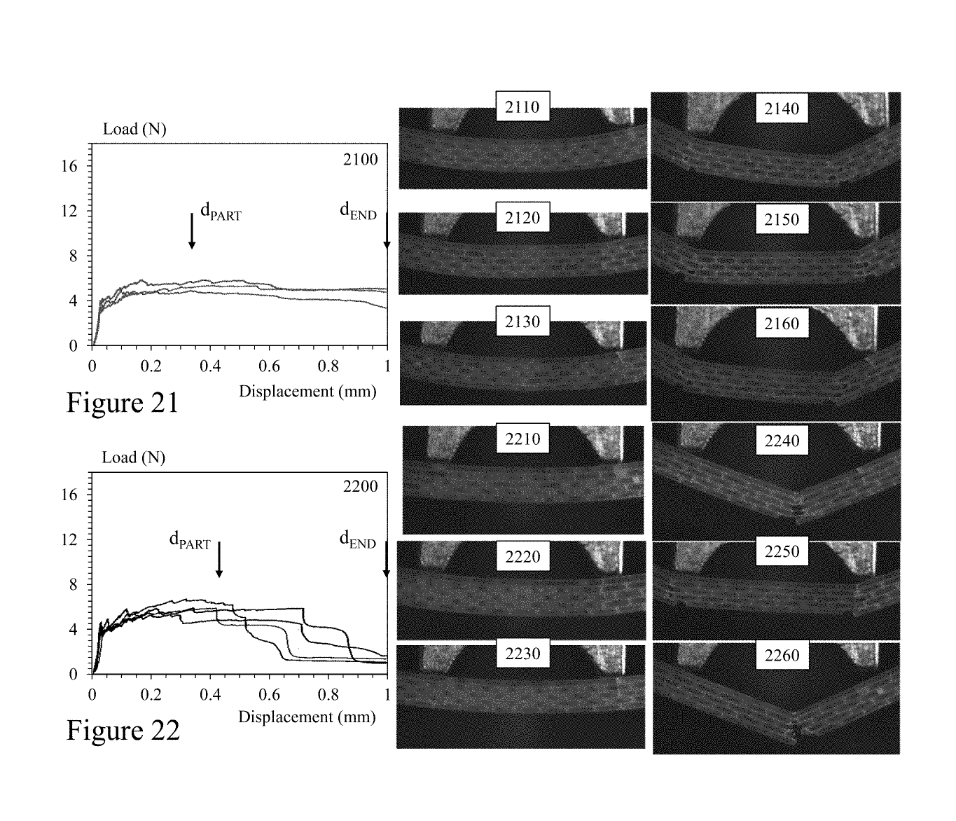

FIG. 21—Group C: First to third images 2110 to 2130 respectively for the samples at d_{PART} and fourth to sixth images 2140 to 2160 respectively at full 1 mm displacement, wherein it can be seen that the structure still maintains structure;

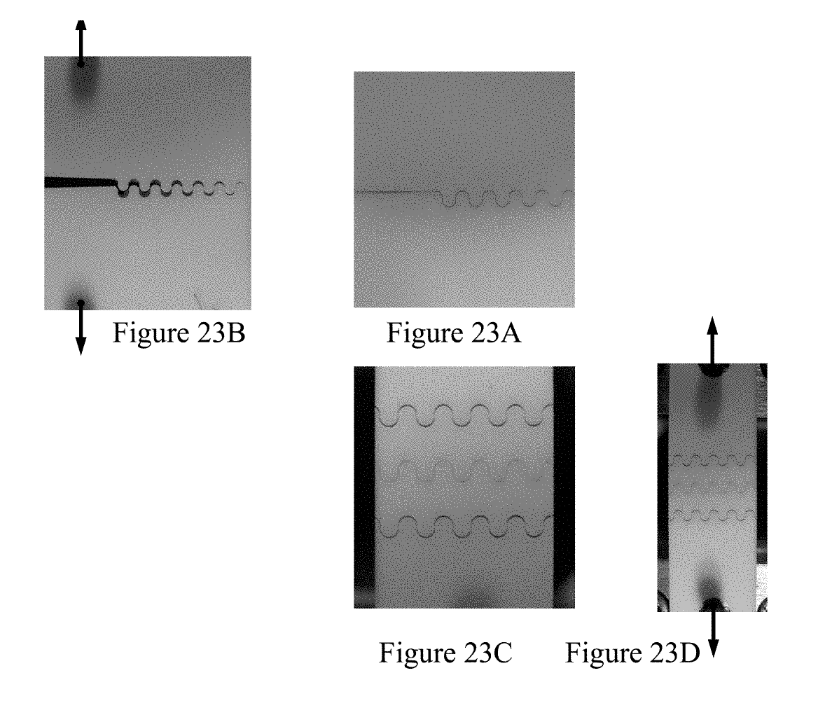

FIG. 22—Group D: First to third images 2210 to 2230 respectively for the samples at d_{PART} and fourth to sixth images 2240 to 2260 respectively at full 1 mm displacement, wherein it can be seen that the structure still maintains mechanical structure but has final structure closer to that of the control samples after failure.

Accordingly, designs may trade failure load bearing with failed structure geometry. As such whilst Groups B and C as depicted in FIGS. 20 and 21 fail at lower loads their failed structure has higher mechanical integrity post-failure for extended displacements.

Accordingly, the embodiments of the invention described with respect to FIGS. 17 to 22 are laminated glass designs where each layer of glass is laser engraved with specific pattern(s). The designs may be optimized to resist flexural stresses and flexural impacts. Examples of such applications may include, for example windshields in cars or aircraft, which required laminated designs to prevent fragments from injuring the vehicle's occupant in case of fracture. Traditional laminated designs consist of glass plates intercalated with polymeric layers. Laminating adds safety but does not significantly increase the impact resistance of the material. This is verified through the results of FIG. 19 wherein the flexural fracture of laminated glass is brittle and the material does not deform much, and fractured in a brittle, catastrophic fashion. FIG. 22 shows a laminated glass according to an embodiment of the invention, where each layer was laser engraved, so that after assembly the structure displays a brick-and-mortar pattern and now the material supports large flexural deformations and the materials absorb significantly more mechanical energy compared to traditional laminated glass. This new bio-inspired laminated glass is therefore much more resistant to impact.

8. Weak Interface Engineered Alumina

Within the preceding analysis in respect of FIGS. 4 to 22 the primary material employed for forming weak interface engineered structures has been glass. However, referring to FIGS. 23A to 23D the inventors have produced these weak interface engineered structures in alumina. Accordingly, as depicted these represent:
FIGS. 23A and 23B respectively depict a fracture toughness test structure according to an embodiment of the invention before and after testing; and
FIGS. 23B and 23D respectively depict a tensile test structure according to an embodiment of the invention in detail and low magnification.

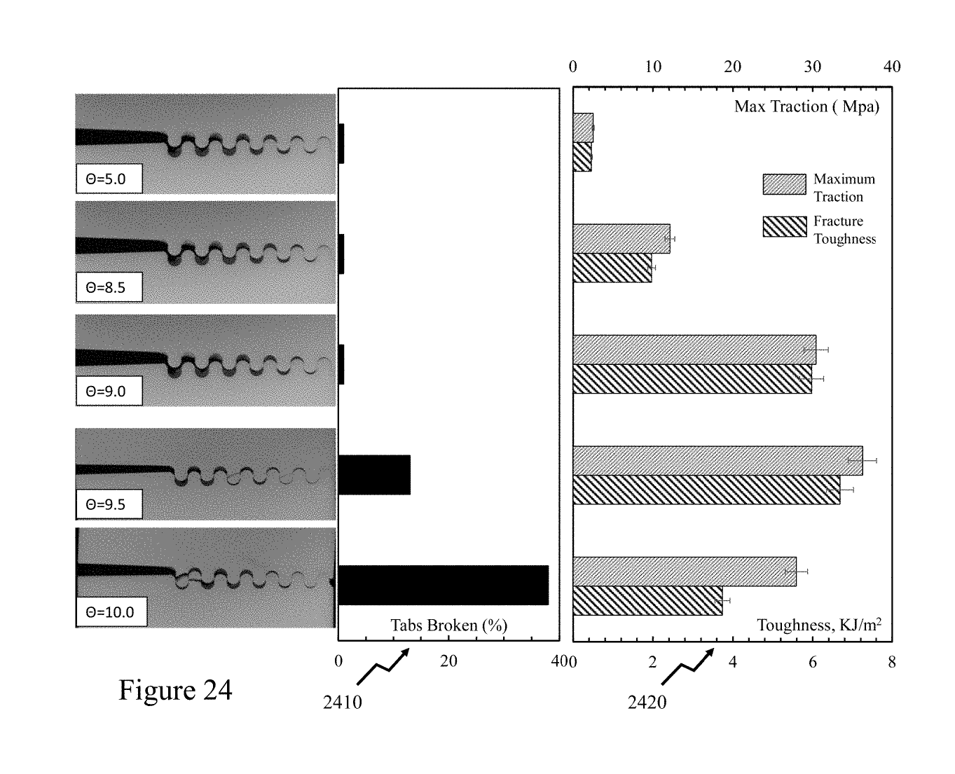

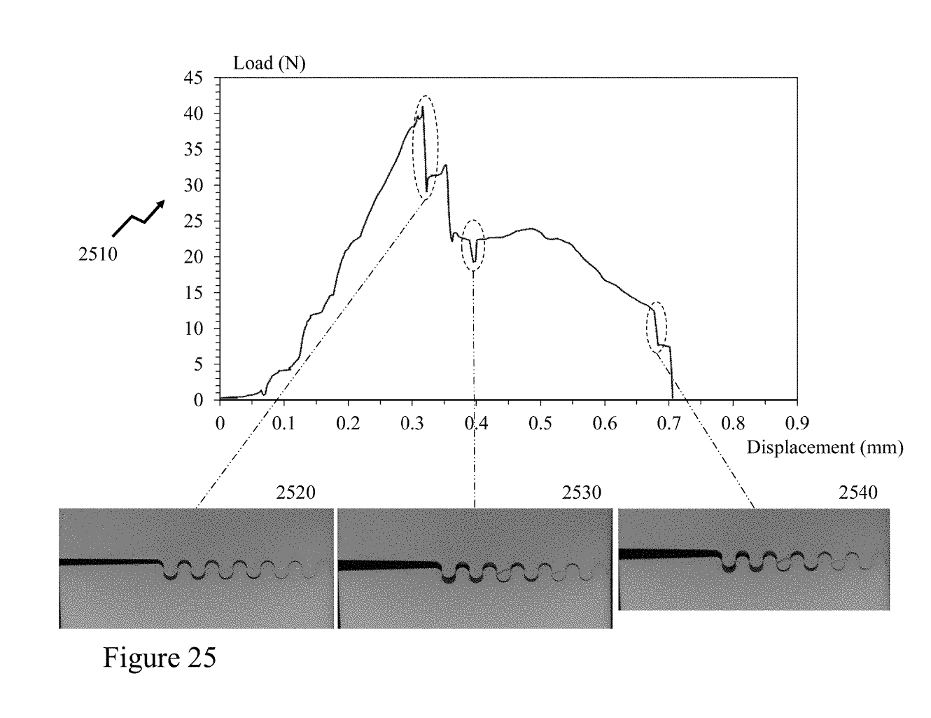

Now referring to FIG. 24 there are depicted depicts the impact and optimization of locking angle on the “jigsaw” test structures on alumina according to embodiments of the invention under fracture testing. As depicted first graph 2410 depicts the number of broken tabs for the different angles of θ=5.0°; 8.5°; 9.0°; 9.5°; 10.0° whilst second graph 2420 depicts the maximum traction and fracture toughness for the same angles wherein it can be seen that maximum traction and fracture toughness occur for θ=9.5° where approximately 13% of tabs break. Referring to FIG. 25 there is depicted an example of the load-displacement results 2510 for a laser engraved alumina “jigsaw” test structure with θ=9.5° according to embodiments of the invention together with first to third images 2520 to 2540 respectively at the three identified locations where sharp transitions occur. Second image 2520 corresponds to first release of a “tab” from its “recess” whilst third image corresponds to the tab failure after the second release.

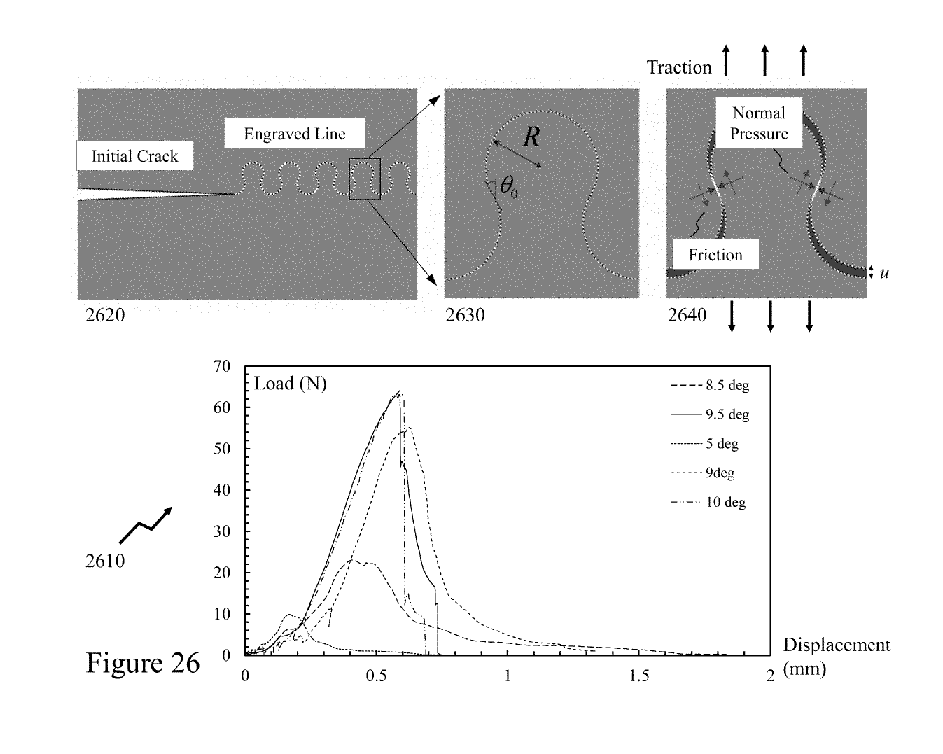

FIG. 26 depicts the load-displacement results 2610 for laser engraved alumina “jigsaw” test structures according to embodiments of the invention with varying locking angle for θ=5.0°; 8.5°; 9.0°; 9.5°; 10.0°. The solid line trace corresponding to the same angle sample θ=9.5° as depicted in FIG. 25. As depicted in first to third images 2620 to 2640 the performance of the “jigsaw” test structure arises from friction between the surfaces as they are brought into contact and normal pressure as the “tab” is engaged within the “recess” and that the resulting angle θ is a function of the “tab” radius, R, and initial separation of the elements, u. Accordingly, at low angle, e.g. θ=5°, the structure separates with relative ease but increasing the angle substantially increases the loading required to separate, see θ=8°; 9°, before the loads become sufficient to fracture the tabs as evident in the drops for θ=9.5°; 10.0°.

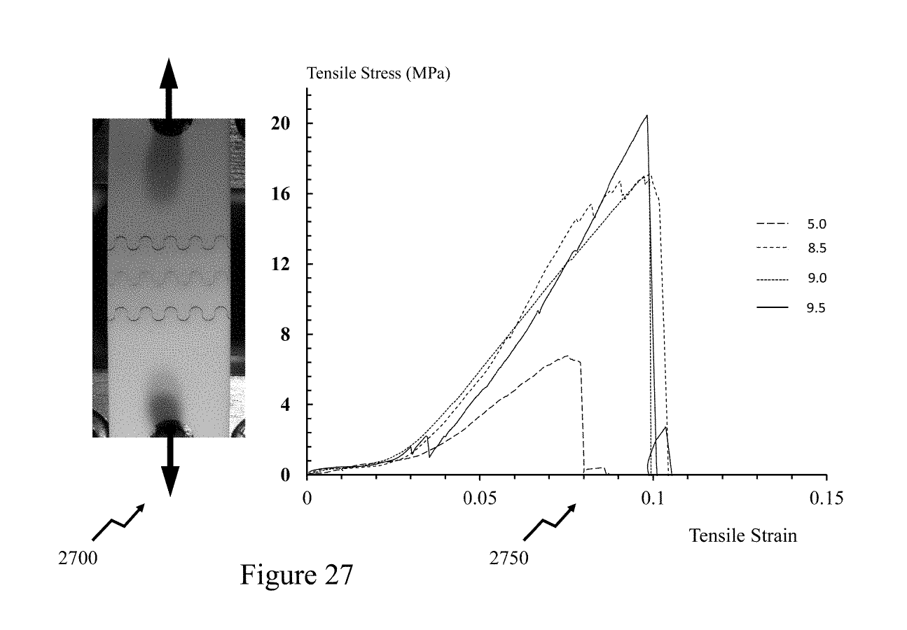

Now referring to FIG. 27 there are depicted tensile load-displacement results 2750 for laser engraved alumina “jigsaw” test structures according to embodiments of the invention with varying locking angle and a schematic of the test configuration 2700. As with the fracture tests increasing locking angle θ increases the tensile stress supported until fracture occurs at approximately constant strain.

9. Weakened Interface Fabrication on Opaque Materials

Within the descriptions supra engraved structures were formed by laser writing defects at low separation. However, writing such structures, particularly in three dimensions (3D), can be time consuming. Further, for non-transparent materials the formation of 3D weakened interfaces becomes impractical unless the material is transparent at wavelengths outside the visible wavelength which can induce damage. Accordingly, the inventors have established a technique for forming weakened interfaces within opaque materials but which can also be applied to transparent materials to reduce processing times.

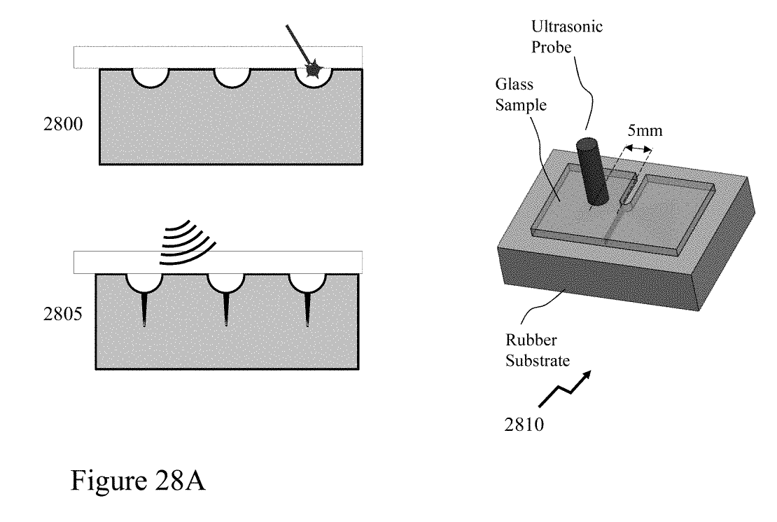

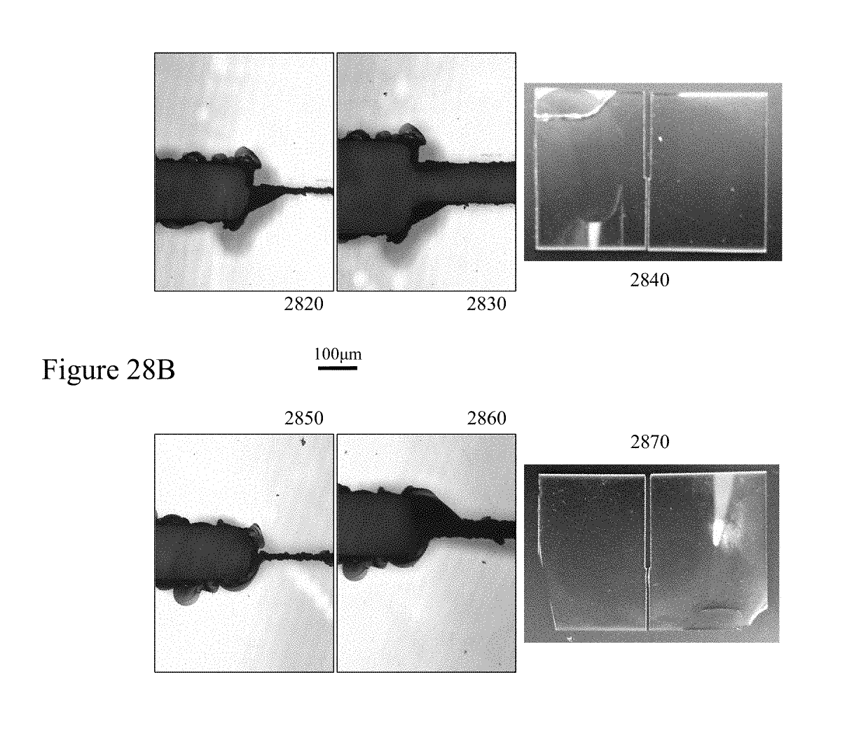

The inventors have demonstrated above that the laser engraving methodology can be used to toughen opaque brittle materials. For example, high density aluminum oxide (alumina) is a whitish engineering ceramic with many attractive properties (high stiffness, high hardness, resistance to high temperatures). However alumina, like other engineering ceramics, suffers from brittleness, which restricts the range of its applications. Using laser engraving the manner in which alumina deforms and fractures can be changed in the same manner as demonstrated with glass as depicted in FIGS. 24 to 27 respectively. For forming weakened interfaces in thin (1-2 mm) plates of alumina as depicted in FIG. 28A in first image 2800 laser engraving is used to make trenches on the surface of the alumina plate, with the desired pattern. Then, as depicted in second image 2805, in a second step, an ultrasonic signal, is applied which extends the cracks into the material and through the thickness by a controlled distance in dependence upon the ultrasonic power and time. With appropriate patterns and engraving conditions, the mechanical solutions implemented for glass were transferred to alumina and may be applied correspondingly to other such materials. Alumina engraved according to this embodiment of the invention is approximately 150 times tougher than regular ceramics (in energy terms). Applications of such modified alumina include high temperature machinery, thermal barrier coatings, machine tools, and mining equipment.

Now referring to FIG. 28B there is depicted the application of this methodology of weakening laser engraved interfaces according to embodiments of the invention for transparent substrates using the configuration presented in FIG. 28A with third image 2810 wherein the ultrasonic probe is positioned approximately 5 mm away from the laser etched feature. However, in other embodiments of the invention, depending upon factors including, but not limited to, the engraved pattern and the material engraved the positioning of the ultrasonic probe may vary including, but not limited to, on the engraved line(s), adjacent the engraved line(s), and predetermined distance from the engraved line(s). Accordingly referring to first image 2820 and fourth image 2850 there are depicted initial laser engraved features upon the surface of a glass substrate comprising a wide slot through the substrate and a narrow laser etched groove. Second and third images 2830 and 2840 respectively depicted the result of 100% high power ultrasonic excitation for one second wherein the width of the groove and channel are clearly increased and the resulting crack propagation from the initial laser etched groove is sufficient to cut through the glass substrate. Fifth and sixth images 2860 and 2870 depict the results of reducing the ultrasonic power to 20% and increasing the time to thirty (30) seconds. Now the increase in the width of the laser etched groove and slot has reduced significantly but the cracks have still propagated through the substrate to separate it into two. As such further reductions in ultrasonic power and adjustments in time may be made to further reduce the expansion of etched/cut features and the depth of crack propagation.

Whilst the experimental demonstrations of embodiments of the invention exploiting the principles established by the inventors for biomimetic structures have focused on millimeter- and sub-millimeter-sized features to demonstrate the key mechanisms, the fabrication methods and principles can also be scaled down to the micrometer and nanometer length scales. For example, 3D laser engraving may exploit femtosecond lasers. The size reduction of the structures enables higher overall strength, following the scaling principles observed in nature. Further, as discussed supra, more complex 3D structures may be implemented either mimicking natural structures or non-natural structures.

3D laser engraving, whilst particularly attractive for transparent materials, may not be possible for other materials due to the absorption/transparency windows of these materials and the availability of fast, typically nanosecond, to ultrafast lasers, picosecond to femtosecond. In other instances, defects may be introduced within materials during their initial manufacturing such as through the introduction of “defect generating sites” within depositions, micro-porous regions, laminating defective materials with defect-free materials, etc. Through adjustment of defect size, defect pattern, defect operation, etc., a material may be architectured using biomimetic concepts according to embodiments of the invention to obtain desirable combinations of strength and toughness. In other embodiments of the invention, defects may be introduced within the material asymmetrically, e.g. from one side of the material, or symmetrically, e.g. with alternating defects projected from alternate sides of the material or a defect formed by introducing structures from either side of the material at the same location. Alternate manufacturing processes may include, but are not limited to, thermal processing, molding, stamping, etching, depositing, machining, and drilling.

The foregoing disclosure of the exemplary embodiments of the present invention has been presented for the purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and the scope of the present invention.

What is claimed is:

1. A method comprising:
etching a plurality of features into at least one of the surface and the volume of a first substrate to tessellate a predetermined portion of the substrate, wherein each feature is the boundary of a geometric shape formed by the introduction of weakening interfaces into the material and any defect arising within a feature of the plurality of features is isolated from the remainder of the first substrate by the feature of the plurality of features.

2. The method according to claim 1, wherein
the first substrate is glass and forms a predetermined portion of a touch screen.

3. The method according to claim 1, wherein
each feature of the plurality of features is at least one of etched into a surface of the first substrate and a series of laser induced defects within the first substrate.

4. The method according to claim 1, wherein
each feature of the plurality of features is formed by at least one of:
providing a three-dimensional pattern comprising a plurality of defects formed within the body of the first substrate; and
providing at least a two-dimensional pattern comprising surface modifications upon at least a surface of the first substrate.

5. A substrate comprising:
a first material in sheet form;
first and second layers of a second material, each of the first and second layers disposed on opposite surfaces of the first material, wherein
at least one surface of the first material disposed adjacent one of the first and second layers of the second material has a plurality of features formed over a predetermined portion of the at least one surface of the first material, wherein each feature is formed by the introduction of weakening interface into the first material and any defect arising within the first material under mechanical loading is controlled through at least one of crack deflection, crack bridging, and micro-cracking.

6. The substrate according to claim 5, wherein
the first material is glass; and
the second material is a polymer bonded to the first material.

7. The method according to claim 5, wherein
each feature of the plurality of features is at least one of etched into a surface of the first substrate and a series of laser induced defects within the first substrate; and
each feature of the plurality of features is disposed to have an angle relative to a projected direction of a defect forming below a predetermined upper angle.

8. The method according to claim 5, wherein
each feature of the plurality of features is formed by at least one of:
providing a three-dimensional pattern comprising a plurality of defects formed within the body of the first substrate; and
providing at least a two-dimensional pattern comprising surface modifications upon at least a surface of the first substrate.

9. A method comprising:
engineering improvements in a predetermined property of a material by the introduction of a plurality of weak interfaces into the material such that the resulting material consists of a plurality of three dimensional interlocking blocks.

10. The method according to claim 9, further comprising
the addition of at least one of an elasto-plastic material and an elastic material to a predetermined portion of the material having the introduced weak interfaces.

11. The method according to claim 9, wherein the
the predetermined property is impact resistance; and
the plurality of three dimensional interlocking blocks slide relative to one another under impact to dissipate the impact.

12. The method according to claim 9, wherein
upon local failure of the material under impact a predetermined portion of the plurality of three dimensional interlocking blocks can be replaced thereby repairing the material.

13. A structure comprising:
a plurality of sheets of first material, each first sheet having a plurality of features formed over a predetermined portion of a surface of the first material adjacent a sheet of a second material, wherein each feature is formed by the introduction of weakening interface into the first material;
a plurality of sheets of the second material, each sheet of the second material disposed between a pair of sheets of the first material.

14. The structure according to claim 13,
the first material is glass; and
the second material is a polymer.

15. The method according to claim 13, wherein
each feature of the plurality of features is formed by at least one of:
providing a three-dimensional pattern comprising a plurality of defects formed within the body of the first substrate; and
providing at least a two-dimensional pattern comprising surface modifications upon at least a surface of the first substrate.

16. The method according to claim 13, wherein
the plurality of features tessellate the surface of the first material and each feature is the boundary of a geometric shape formed by the introduction of the weakened interfaces into the material.

17. The method according to claim 13, wherein
the plurality of features are blocks of predetermined geometry such that a ratio of a first dimension of the block relative to the thickness of the first material at least one of fits within a predetermined range and exceeds a predetermined threshold value.

18. A method comprising:
forming a plurality of features within the surface of a first material; and
ultrasonically agitating the first material at a predetermined power for a predetermined time in order to propagate at least one of cracks and micro-cracks within the volume of the first material in order to form a weak interface associated with each feature of the plurality of features.

19. The method according to claim 18, wherein
the first material is opaque and each feature of the plurality of features is formed by providing at least a two-dimensional pattern comprising surface modifications upon the surface of the first material.

20. The method according to claim 18, wherein
the first material is transparent and each feature of the plurality of features is formed by at least one of:
providing a three-dimensional pattern comprising a plurality of defects formed within the body of the first substrate where each defect of the plurality of defects was induced through localized optical absorption; and
providing at least a two-dimensional pattern comprising surface modifications upon at least a surface of the first material.
